(19) United States
(12) Patent Application Publication
(10) Pub. No.: US 2010/0289619 A1
(43) Pub. Date: Nov. 18, 2010

(54) ANTENNA DEVICE

(75) Inventors: Masanori KOSUGI, Aichi (JP); Fumikazu KOBAYASHI, Aichi (JP)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: KABUSHIKI KAISHA TOKAI RIKA DENKI SEISAKUSHO, Aichi (JP)

(21) Appl. No.: 12/774,496

(22) Filed: May 5, 2010

(30) Foreign Application Priority Data
May 13, 2009 (JP) 2009-117082

(51) Int. Cl. G05B 19/00

(52) U.S. Cl. 340/5.61

(57) ABSTRACT

An antenna device includes an antenna element, a wireless circuit, and electronic circuit, a substrate, a conductor, and a stub. The antenna element transmits or receives a communication signal. The wireless circuit is connected to the antenna element. The electronic circuit differs from the wireless circuit. The wireless circuit and electronic circuit are arranged in positional isolation on the substrate. The conductor is connected to the substrate to connect the antenna device to another device. The stub is arranged in a substrate part in which the wireless circuit is located. The stub has a pattern length that causes resonance at one fourth of a wavelength of the communication signal.

### CROSS-REFERENCE TO RELATED APPLICATIONS

This application is based upon and claims the benefit of priority from prior Japanese Patent Application No. 2009-117082, filed on May 13, 2009, the entire contents of which are incorporated herein by reference.

### BACKGROUND OF THE INVENTION

The present invention relates to an antenna device that transmits and receives various types of radio waves.

An electronic key system installed in a vehicle uses an electronic key as a vehicle key that transmits a unique key code through wireless communication to the vehicle. One type of such an electronic key system is a wireless key system that requires the operation of a button to transmit the key code. In such a wireless key system, when a lock button of the electronic key is pushed, a lock request radio wave, which includes a key code, is transmitted from the electronic key to the vehicle. Upon receipt of the lock request radio wave, the vehicle locks unlocked doors if the key code in the radio wave is correct. When an unlock button of the electronic key is pushed, an unlock request radio wave, which includes the key code, is transmitted from the electronic key to the vehicle. When the key code in the radio wave is correct, the vehicle unlocks locked doors.

The electronic key system includes an antenna, which is installed in the vehicle to receive various types of radio waves transmitted from the electronic key. One example of such an antenna is an inverted L antenna. The inverted L antenna has the shape of inverted letter L from the alphabet. Japanese Laid-Open Patent Publication No. 2003-8331 describes an example of an inverted L antenna. FIG. 1 is a schematic diagram showing the structure of an inverted L antenna 110, which is described in the publication. As shown in the drawing, the inverted L antenna 110 includes a generally U-shaped antenna element 112, which has a vertical end extending orthogonally to a substrate 107 and a horizontally extending portion bent twice by 90 degrees. The antenna element 112 is arranged on a conductive surface, which is larger than the antenna element 112, and has a length set to be, for example, one fourth the wavelength. In this case, the vehicle body or substrate that is larger than the wavelength may function as the conductive surface. As the size of the conductive surface becomes greater than the wavelength, the antenna properties are further stabilized.

A wire harness 130 is connected to the substrate 107, on which the antenna 100 is mounted, to connect the antenna device 105 to another device. However, when coupling the antenna device 105 to a vehicle body or the like, the layout situation (e.g., length and position) of the wire harness 130 differs in accordance with the application. For example, the length of the antenna element 112 is determined by the wavelength. However, when the antenna device 105 is required to be reduced in size, the substrate 107 must also be miniaturized. The antenna properties obtained with a large substrate may not be obtained when the substrate 107 is miniaturized in such a manner. Further, in the inverted L antenna 110, the antenna element 112 does not function as an antenna by itself. Rather, the antenna element 112 cooperates with the substrate 107 to function in the same manner as a dipole. Thus, the image produced on a ground plane of the substrate 107 affects the antenna properties. Moreover, the conductive surface may have an area that is not sufficiently larger than the wavelength. In such a case, when the layout situation of the wire harness 130 differs depending on the application, the wire harness 130, which is a conductor, functions as the ground plane and may thereby vary the antenna directivity. This may destabilize the antenna properties. Such a problem occurs in any antenna device that has a substrate connected to a conductor, such as a wire harness connecting the antenna device to another device. That is, in the antenna device of the prior art, a conductor functioning as the ground plane, which is affected by the layout situation of the conductor, varies and destabilizes the antenna properties. Accordingly, it is desirable that the antenna properties be stabilized without being affected by the state (position, length, and shape) of such a conductor.

### SUMMARY OF THE INVENTION

The present invention provides an antenna device that stabilizes the antenna properties regardless of the state of a conductor connected to the antenna device.

One aspect of the present invention is an antenna device including an antenna element that transmits or receives a communication signal, a wireless circuit connected to the antenna element, an electronic circuit that differs from the wireless circuit, and a substrate on which the wireless circuit and electronic circuit are arranged in positional isolation. A conductor is connected to the substrate to connect the antenna device to another device. A stub is arranged in a substrate part in which the wireless circuit is located, the stub having a pattern length that causes resonance at one fourth of a wavelength of the communication signal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing an antenna device of the prior art;

FIG. 2 is a schematic diagram showing an electronic key system;

FIG. 3 is a schematic diagram showing an antenna device according to one embodiment of the present invention;

FIG. 4 is a waveform chart showing the antenna directivity of a horizontal polarized wave on a horizontal plane;

FIG. 5 is a schematic diagram showing a modification of the antenna device of FIG. 3;

FIG. 6 is a schematic diagram showing a balun arranged in the antenna device of FIG. 5;

FIG. 7 is a schematic diagram showing a modification of the antenna device of FIG. 3; and

FIG. 8 is a schematic diagram showing a modification of the antenna device of FIG. 3.

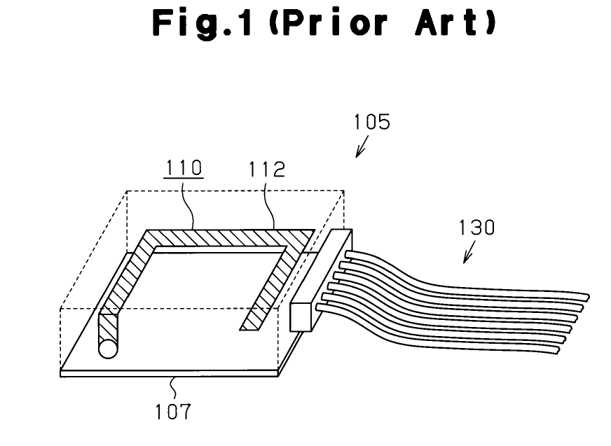

### DETAILED DESCRIPTION OF THE INVENTION

### First Embodiment

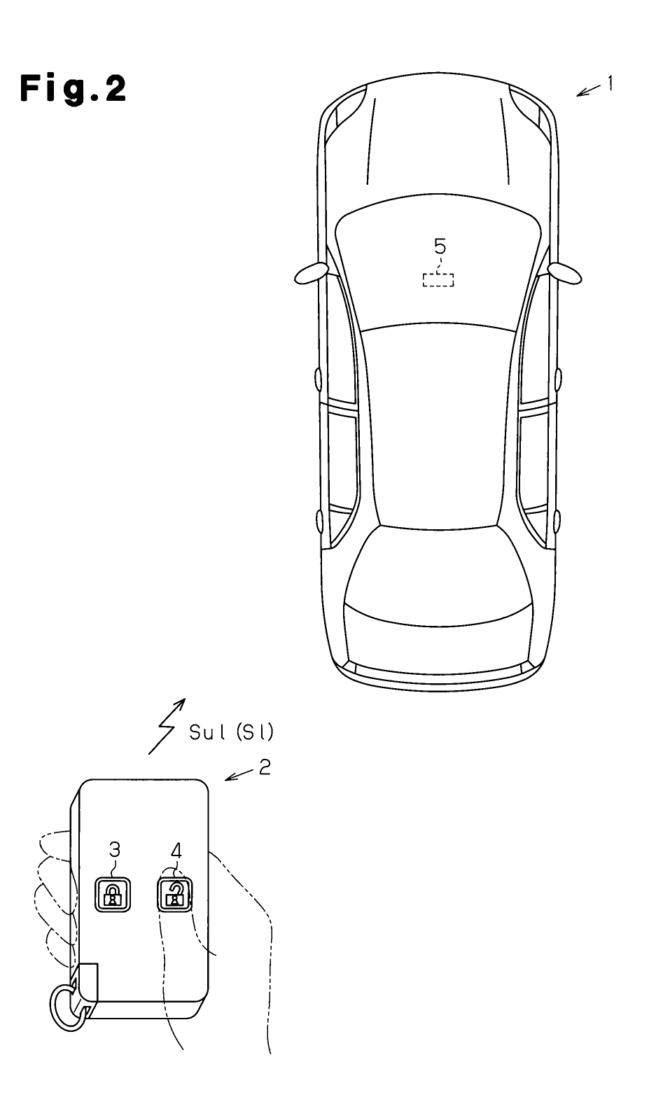

One embodiment of an antenna device applied to a reception antenna 5 will now be discussed with reference to FIGS. 2 to 4.

Referring to FIG. 2, a wireless key system, which is one type of an electronic key system, is installed in a vehicle 1. The wireless key system includes a wireless key 2, which transmits a unique key code through wireless communication when a button is operated. The wireless key 2, which functions as an electronic key, uses the radio frequency (RF) band as a communication frequency that carries signals. The wireless key 2 includes a lock button 3, which is operated to lock a door of the vehicle 1 (close a door lock), and an unlock button 4, which is operated to unlock the door of the vehicle 1 (open the door lock). The reception antenna 5 is installed in the vehicle 1 and thereby functions as a vehicle antenna. The reception antenna 5 corresponds to an antenna device.

In the wireless key system, when the lock button 3 of the wireless key 2 is pushed, the wireless key 2 transmits a lock request radio wave S1 in the RF band as a signal to the vehicle 1. The lock request radio wave S1 includes a key code of the wireless key 2 and a lock request code for instructing the vehicle 1 to perform locking. When the reception antenna 5 receives the lock request radio wave S1, the vehicle 1 performs key verification with the key code included in the lock request radio wave S1. When the key verification is successful, the door of the vehicle 1 is locked in accordance with the lock request code. When the unlock button 4 of the wireless key 2 is pushed, the wireless key 2 transmits an unlock request radio wave Su1 in the RF band as signal to the vehicle 1. The unlock request radio wave Su1 includes the key code of the wireless key 2 and an unlock request code for instructing the vehicle 1 to perform unlocking. When the reception antenna 5 receives the unlock request radio wave Su1, the vehicle 1 performs key verification with the key code included in the unlock request radio wave Su1. When the key verification is successful, the door of the vehicle 1 is unlocked in accordance with the unlock request code.

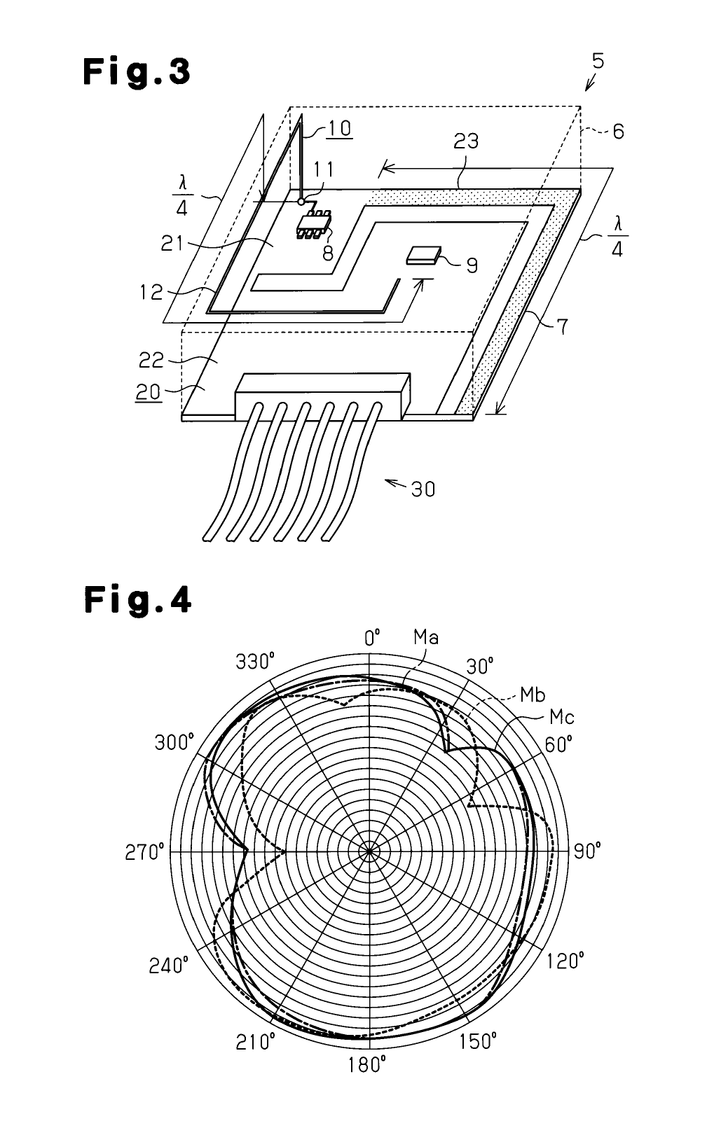

As shown in FIG. 3, the reception antenna 5 includes a plate-shaped substrate 7. Various antenna components of the reception antenna 5 are mounted on the substrate 7. A housing 6 accommodates the substrate 7. The housing 6 is coupled to a vehicle body to install the reception antenna 5 in the vehicle 1.

Pattern wiring 20 (circuit wiring), which serves as a circuit wiring, is formed on the substrate 7. The pattern wiring 20 is separated into a first pattern portion 21 (first wiring portion) and a second pattern portion 22 (second wiring portion) on the substrate 7. As viewed in FIG. 3, in this example, the first pattern portion 21 is located at the upper left part of the substrate 7, and the second pattern portion 22 is located at the lower part of the substrate 7. Preferably, the first pattern portion 21 is sufficiently smaller than the entire area of the substrate 7. In this example, the first pattern portion 21 is approximately one-sixth the entire area of the substrate 7. The first and second pattern portions 21 and 22 are partially connected when the same potential, such as ground (GND), is necessary. A wireless circuit 8 and an electronic circuit 9 are arranged on the pattern wiring 20. The wireless circuit 8 manages the reception operation of the reception antenna 5. The electronic circuit 9 controls the reception operation. The wireless circuit 8 is arranged on the first pattern portion 21, and the electronic circuit 9 is arranged on the second pattern portion 22. Thus, the wireless circuit 8 and the electronic circuit 9 are arranged in positional isolation from each other on the substrate 7.

A pattern stub 23 (shaded part in FIG. 3), which has a pattern length allowing for resonance to occur at one fourth of a wavelength of a reception signal (communication signal), is formed in the first pattern portion 21, which includes the wireless circuit 8. For example, the pattern stub 23 is laid out along two sides (upper edge and right edge in FIG. 3) of the substrate 7. By using the edges of the substrate 7, the pattern stub 23 is efficiently formed within the limited space of the substrate 7. One fourth of a wavelength refers to one fourth of a single wavelength of a reception signal. A pattern length that causes resonance at one fourth of the wavelength includes a pattern length that is equal to one fourth of the wavelength as shown in FIG. 3. However, the pattern stub 23 may be formed to be longer than one fourth of the wavelength. In this case, the pattern length may be varied as long as it is obtained by adding the product of one half of the wavelength and a natural number to one fourth of the wavelength (i.e., λ/4+(n×λ/2), where λ represents a wavelength and n represents a natural number). Further, when forming the pattern wiring 20 on the substrate 7, the pattern length of the pattern stub 23 may be shorter than one fourth of the wavelength due to the permittivity of a dielectric on the substrate 7. Accordingly, a pattern length that causes resonance at one fourth of the wavelength refers to a pattern length that causes the pattern stub to resonate at one fourth of the wavelength. This includes a pattern that is slightly shorter than one fourth of the wavelength.

An inverted L antenna 10 is mounted on the substrate 7. The inverted L antenna 10 includes an antenna element 12, which serves as an antenna line. The antenna element 12, which is a component formed from, for example, metal such as aluminum, is arranged generally parallel to the substrate 7. The inverted L antenna 10 does not function as an antenna just with the antenna element 12. The antenna element 12 affects and cooperates with the substrate 7 to function in the same manner as a dipole. The antenna element 12 includes an end portion, which extends in the vertical direction from a power supply point 11 (power supply terminal) on the substrate 7 and is bent 90 degrees. From this bent end portion, the antenna element 12 is bent twice by 90 degrees and extends in the horizontal direction. Thus, the antenna element 12 is generally U-shaped and lies along a plane parallel to the substrate 7. The antenna element 12 has a length set to be equal to one fourth of the wavelength. The length of the antenna element 12 does not have to be equal to the length of the pattern stub 23. For example, the antenna element 12 may have a length that is equal to one fourth of the wavelength, and the pattern stub 23 may have a length that is equal to three fourths of the wavelength. The power supply point 11 is set at one position on the pattern wiring 20 (first pattern portion 21) of the substrate. When receiving a radio wave, the antenna provides the wireless circuit 8 with current that is in accordance with the received radio wave (progressive wave).

A wire harness 30, which serves as a conductor, is connected to the substrate 7. The wire harness 30 connects the reception antenna 5 to another device or power supply in the vehicle 1. When coupling the reception antenna 5 to the vehicle body, the layout situation and form of the wire harness 30 arranged on the vehicle body may differ for each application. In the reception antenna of the prior art, when the layout situation of a wire harness changes, the wire harness, which is a conductor, functions as a ground plane for the antenna element. This may vary the antenna properties and thereby destabilize the antenna properties.

To solve this problem, in the reception antenna 5 of the present example, the pattern stub 23, which has a pattern length that causes resonance at one fourth of the wavelength, is formed in the first pattern portion 21, which includes the wireless circuit 8. Accordingly, the antenna element 12 of the antenna 10 resonates with the pattern stub 23 and stabilizes the antenna properties. In this case, the shape of the pattern stub 23 formed on the substrate 7 remains the same. Thus, the antenna properties do not vary. Accordingly, the antenna properties are stabilized.

The antenna directivity of the reception antenna 5 is an index that indicates the reception sensitivity of the reception antenna 5 with respect to various radio waves transmitted from the wireless key 2. More specifically, the antenna directivity is indicated by a value representing the reception sensitivity with respect to the direction of the antenna element 12 (inverted L antenna 10). A higher antenna directivity value indicates a higher reception sensitivity. The ideal antenna directivity is round (circular) so that whichever direction the wireless key 2 transmits a radio wave to the antenna 10 (vehicle 1), the transmitted radio wave reaches the antenna 10 from about the same distance. Thus, in this type of reception antenna 5, there is a demand that the antenna directivity be as round as possible. A rounder antenna directivity improves the antenna properties.

When discussing the antenna directivity, the antenna directivity roundness on a plane extending in the horizontal direction (horizontal plane), which serves as a reception plane of the antenna 10 in the vehicle 1, must be taken into consideration. The wireless key 2 is used to transmit radio waves in the horizontal direction near the vehicle 1 (in a direction extending along the ground surface). Thus, the radio wave transmission direction of the wireless key 2 extends along a horizontal plane.

FIG. 4 is a chart showing the antenna directivity of the reception antenna 5 in the present example. In the chart of FIG. 4, the marks in the circumferential direction represent angles (0 degrees to 360 degrees) and the marks in the radial direction represent reception sensitivities. In the chart, the single-dashed line shows a waveform Ma indicating the antenna directivity for the reception antenna of the prior art and the reception antenna 5 of the present example when the wire harness 30 is arranged at the desired position, that is, the originally designed position. The broken line shows a waveform Mb indicating the antenna directivity for the reception antenna of the prior art when the wire harness is not arranged at the desired position, that is, when the wire harness is displaced within a tolerance. The solid line shows a waveform Mc indicating the antenna directivity for the reception antenna 5 of the present example when the wire harness 30 is not arranged at the desired position, that is, when the wire harness 30 is displaced within a tolerance.

The waveform Mb, which is for the reception antenna of the prior art when the wire harness is not arranged at the desired position, is more greatly deviated from a circle than the waveform Ma, which is for the reception antenna of the prior art and the reception antenna 5 of the present example when the wire harness 30 is arranged at the desired position. However, the waveform Mc, which is for the reception antenna 5 of the present example when the wire harness 30 is not arranged at the desired position, varies subtly from the waveform Ma, which is for the reception antenna 5 of the present example when the wire harness 30 is arranged at the desired position. This shows that the layout situation of the wire harness 30 does not affect the directivity of the reception antenna 5.

The antenna device of the first embodiment has the advantages described below.

(1) The wireless circuit 8 and the electronic circuit 9 are arranged in positional isolation from each other on the substrate 7. Further, the pattern wiring 20 arranged on a semiconductor portion of the substrate 7 is divided into the first and second pattern portions 21 and 22. This prevents the second pattern portion 22, which includes the electronic circuit 9, from functioning as a ground plane and maintains the desirable antenna properties. This structure is particularly desirable since the antenna element 12 does not function as an antenna by itself in the inverted L antenna 10 and cooperates with the substrate 7 to function in the same manner as a dipole. Further, the first pattern portion 21, which includes the wireless circuit 8, includes the pattern stub 23, which has a pattern length that causes resonance at one fourth of the wavelength. In this structure, the antenna element 12 resonates with the pattern stub 23 and stabilizes the antenna properties. Since the shape of the pattern stub 23 formed on the substrate 7 remains the same, the antenna directivity does not vary even when the layout situation or shape of the wire harness 30 connected to the substrate differs between applications. In other words, resonance of the antenna element 12 with the pattern stub 23 occurs regardless of the layout situation (position or shape) of the wire harness 30. This prevents a conductor connected to the reception antenna 5, such as the wire harness 30, from affecting the antenna properties and thereby stabilizes the antenna properties.

(2) The first pattern portion 21, which includes the wireless circuit 8, is formed to be sufficiently smaller in size than the entire substrate 7. In other words, the ratio of the area for the first pattern portion 21 occupying the substrate 7 is small. This prevents the second pattern portion 22 from functioning as the ground plane and maintains the desirable antenna properties.

### Second Embodiment

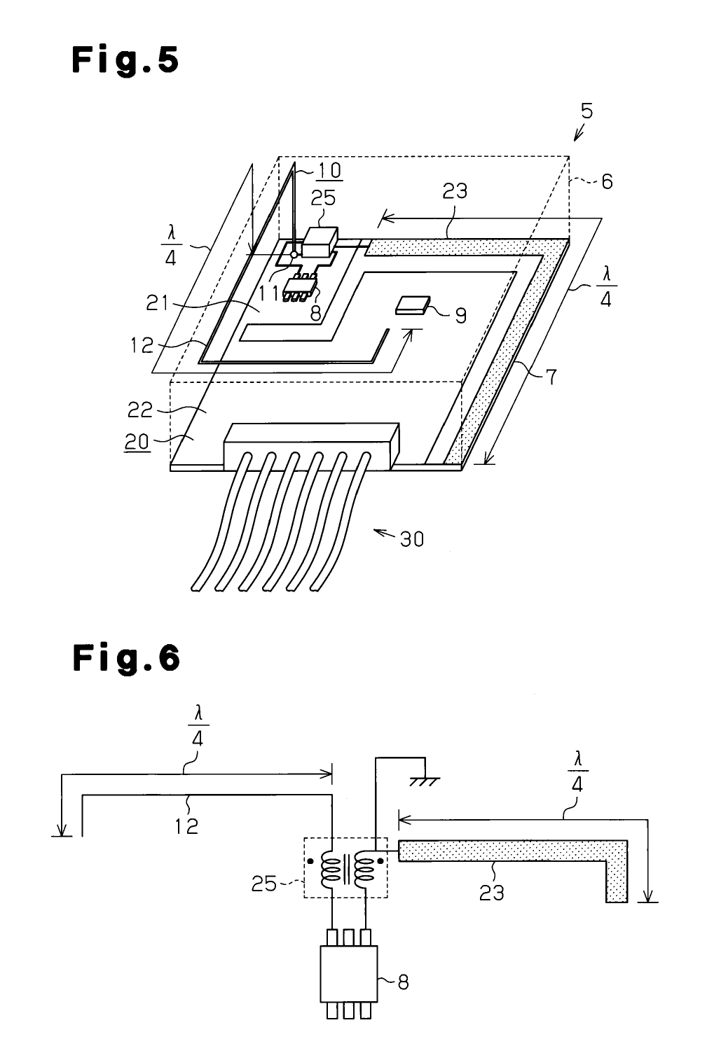

A second embodiment of an antenna device applied to a reception antenna 5 will now be discussed with reference to FIGS. 5 and 6. The reception antenna 5 of the second embodiment differs from the first embodiment in that it includes a balun 25, which is a balanced to unbalanced converter. The difference from the first embodiment will now be discussed. The antenna device of the second embodiment has a structure that is similar to that of the antenna device of the first embodiment shown in FIG. 3.

Referring to FIG. 5, the balun 25 is arranged on the first pattern portion 21. The balun 25 is arranged between the antenna element 12 and the wireless circuit 8 and between the pattern stub 23 and the wireless circuit 8 so that unbalanced current does not flow to the antenna element 12 and the pattern stub 23.

For example, as shown in FIG. 6, the balun 25 is connected between the wireless circuit 8 and the antenna element 12 and includes a transformer connected between the wireless circuit 8 and the pattern stub 23. The pattern stub 23 is connected to ground.

In addition to advantages (1) and (2) of the first embodiment, the second embodiment has the advantage described below.

(3) The balun 25 resonates in correspondence with resonance of the antenna element 12. The balun 25 prevents unbalanced current from flowing to the antenna element 12 and the pattern stub 23 and allows balanced current to flow to the wireless circuit 8. This prevents the antenna properties from being destabilized by unbalanced currents.

### Third Embodiment

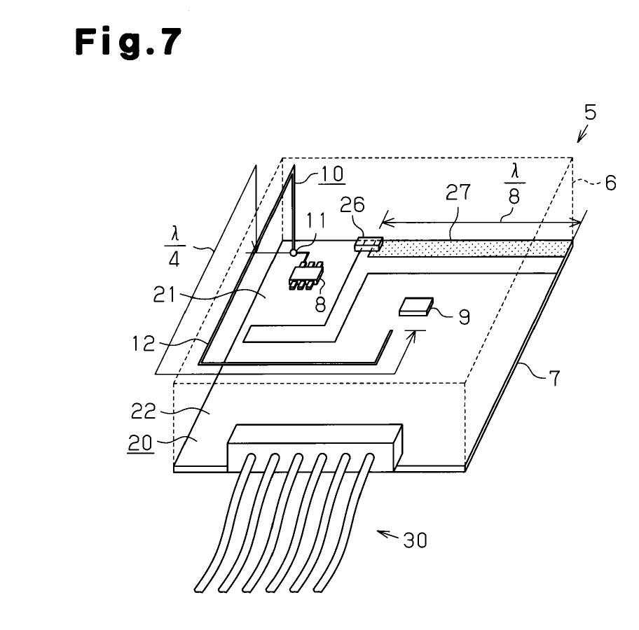

A third embodiment of an antenna device applied to a reception antenna 5 will now be discussed with reference to FIG. 7. The reception antenna 5 of the third embodiment differs from the first embodiment in that a pattern stub 27 is combined with a resonator. The difference from the first embodiment will now be discussed. The antenna device of the third embodiment has a structure that is similar to that of the antenna device of the first embodiment shown in FIG. 3.

Referring to FIG. 7, the pattern stub 27 has a length that is set to be approximately one eighth of the wavelength, which is shorter than the one fourth of the wavelength in the first embodiment. The second pattern portion 22 has an area that is wider than that of the second pattern portion 22 in the first embodiment (refer to FIG. 5). More specifically, in the antenna structure of the third embodiment, the second pattern portion 22 is enlarged, and the pattern stub 27 cannot have a length that is one fourth of the wavelength. The first pattern portion 21 and the pattern stub 27 are isolated from each other. A lumped constant circuit 26, which functions as the resonator, is arranged between the first pattern portion 21 and the pattern stub 27. In the present example, the lumped constant circuit 26 is an inductor (L). Further, the lumped constant circuit 26 functions as part of the pattern stub 27 and resonates the antenna element 12 and the pattern stub 27 even though the pattern stub 27 is shorter than one fourth of a wavelength.

In addition to advantages (1) and (2) of the first embodiment, the antenna device of the third embodiment has the advantage described below.

(4) An inductor (lumped constant circuit 26) is used as a resonator in lieu of part of the pattern stub 27. Even when the pattern stub 27 on the substrate 7 does not have a pattern length that causes resonance at one fourth of the wavelength, the antenna element 12 and the pattern stub 27 are resonated at the same frequency. Thus, the pattern stub 27 that causes resonance at one fourth of a wavelength may have a shorter length (for example, a length that is shorter than one fourth of the wavelength).

It should be apparent to those skilled in the art that the present invention may be embodied in many other specific forms without departing from the spirit or scope of the invention. Particularly, it should be understood that the present invention may be embodied in the following forms.

In the second embodiment, the balun 25 does not need to be of a transformer type and may have a structure of another type.

In the third embodiment, the pattern length of the pattern stub 27 is not limited to one eighth of a wavelength and may be varied in accordance with the pattern length of the pattern stub 27.

In the third embodiment, the lumped constant circuit 26 is used in lieu of part of the pattern stub 27. However, the lumped constant circuit 26 may be used in lieu of the entire pattern stub 27. Further, instead of or in addition to arranging the lumped constant circuit 26 (resonator) at one end of the pattern stub 27 as shown in FIG. 7, the lumped constant circuit 26 may be arranged in a middle part of the pattern stub 27. For example, a plurality of lumped constant circuits 26 (resonators) may be arranged connecting two or more pattern stubs.

In the third embodiment, the lumped constant circuit 26, which serves as a resonator, may be a capacitor (C) instead of an inductor (L). Otherwise, the lumped constant circuit 26 may be an LC circuit, which includes an inductor and a capacitor.

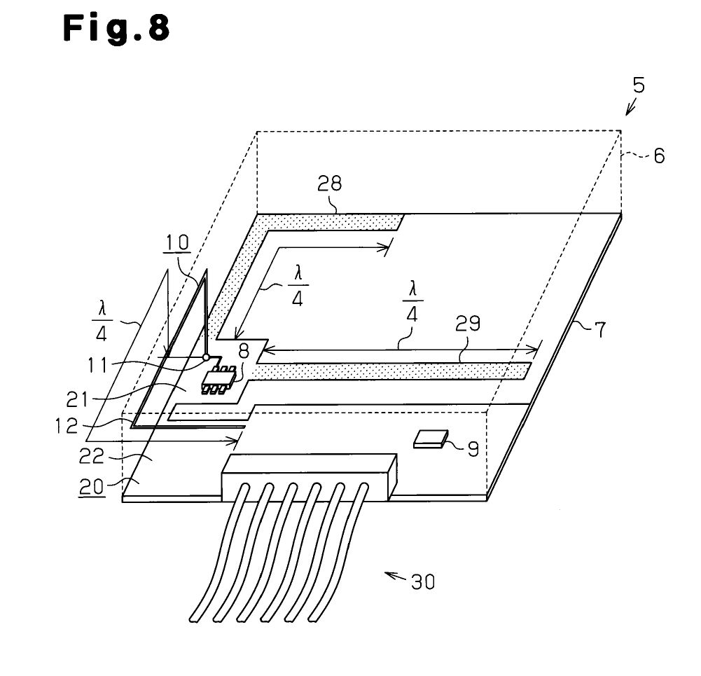

In the above-described embodiments, the quantity of the pattern stub 23 is not limited to one. A plurality of pattern stubs may be arranged in the first pattern portion 21. For example, FIG. 8 shows a modification of the first embodiment (FIG. 3). In the example shown in FIG. 8, the first pattern portion 21 is located in part of the left side of the substrate 7, and the second pattern portion 22 is located at the lower side of the substrate 7. A plurality of stubs, for example, a first pattern stub 28 and a second pattern stub 29, are connected to the first pattern portion 21. Each of the pattern stubs 28 and 29 has a pattern length that allows for resonance to occur at one fourth of the wavelength. Here, each of the first and second pattern stubs 28 and 29 has a length that is one fourth of the wavelength. In this structure, at least one of the pattern stubs 28 and 29, which causes resonance at one fourth of the wavelength, functions as a ground plane and thereby prevents a wire harness or the like from functioning as a ground plane. Thus, the antenna properties do not vary even when the layout situation of the conductor connected to the substrate changes. This obtains stable antenna properties.

In the above-described embodiments, the first pattern portion 21 including the wireless circuit 8 on the substrate does not have to be formed to be sufficiently small relative to the entire area of the substrate 7.

In the above-described embodiments, the antenna 10 is not limited to an inverted L antenna and may be a monopole antenna. Alternatively, the antenna 10 may be a T antenna or any antenna of which the antenna properties are affected by an image produced in a ground plane of the substrate 7.

In the above-described embodiments, the antenna device is not limited to the reception antenna 5 and may be, for example, a transmission antenna. Alternatively, the antenna device may be a transmission-reception antenna that is used for both signal transmission and signal reception. In such a case, one fourth of the wavelength refers to one fourth of a wavelength of a transmission-reception signal, and one eighth of a wavelength refers to one eighth of a wavelength of the transmission-reception signal.

The electronic key system is not necessarily limited to a wireless key system and may be a key-operation-free system that automatically transmits a key code from an electronic key (vehicle key). In such a key-operation-free system, the vehicle continuously or intermittently transmits a key code reply request. In response to the request, the electronic key returns a key code to the vehicle 1.

In the above-described embodiments, the antenna device (reception antenna 5 or the like) does not have to be installed in the vehicle 1 and may be used in any device or apparatus that performs wireless communication.

The present examples and embodiments are to be considered as illustrative and not restrictive, and the invention is not to be limited to the details given herein, but may be modified within the scope and equivalence of the appended claims.

What is claimed is:

1. An antenna device comprising:
an antenna element that transmits or receives a communication signal;
a wireless circuit connected to the antenna element;
an electronic circuit that differs from the wireless circuit;
a substrate on which the wireless circuit and electronic circuit are arranged in positional isolation;
a conductor connected to the substrate to connect the antenna device to another device; and
a stub arranged in a substrate part in which the wireless circuit is located, the stub having a pattern length that causes resonance at one fourth of a wavelength of the communication signal.

2. The antenna device according to claim 1, wherein the substrate part in which the wireless circuit is located is formed to be sufficiently small in size relative to the entire substrate.

3. The antenna device according to claim 1, wherein the substrate includes:
a first wiring portion connected to the wireless circuit; and
a second wiring portion connected to the electronic circuit and separated from the first wiring portion,
wherein the stub is formed on the first wiring portion which extends along an edge of the substrate.

4. The antenna device according to claim 1, wherein the pattern length that causes resonance at the one fourth of the wavelength is expressed by the expression of:
λ/4+(n×λ/2), where λ represents the wavelength and n represents a natural number.

5. The antenna device according to claim 1, wherein the stub is one of a plurality of stubs arranged in the substrate part in which the wireless circuit is located, and each of the stubs has a pattern length that causes resonance at the one fourth of the wavelength of the communication signal.

6. The antenna device according to claim 1, further comprising:
a balanced to unbalanced converter arranged between the antenna element and the wireless circuit and between the stub and the wireless circuit.

7. The antenna device according to claim 6, wherein the balanced to unbalanced converter includes a transformer, the transformer being connected to the antenna element, the stub, and the wireless circuit.

8. The antenna device according to claim 1, further comprising:
a resonator connected to the stub to resonate in correspondence with resonance of the antenna element.

9. The antenna device according to claim 8, wherein the resonator includes a lumped constant circuit formed by at least one of an inductor and a capacitor.

10. The antenna device according to claim 8, wherein the resonator is arranged at one end or a middle part of the stub.

11. The antenna device according to claim 8, wherein the stub has a pattern length that is set to be shorter than the one fourth of the wavelength.
